(19) United States
(12) Patent Application Publication
(10) Pub. No.: US 2024/0076108 A1
(43) Pub. Date: Mar. 7, 2024

(54) PAINT APPLICATION DEVICE STORAGE ASSEMBLY

(71) Applicant: Ray Garza, Jr., Sugar Land, TX (US)

(72) Inventor: Ray Garza, Jr., Sugar Land, TX (US)

(21) Appl. No.: 18/241,508

(22) Filed: Sep. 1, 2023

Related U.S. Application Data
(60) Provisional application No. 63/403,414, filed on Sep. 2, 2022.
(60) Provisional application No. 63/422,497, filed on Nov. 4, 2022.

(51) Int. Cl. B65D 51/28; B44D 3/12; B65D 43/02

(52) U.S. Cl. CPC B65D 51/28; B44D 3/123; B65D 43/0204; B65D 2543/00092

(57) ABSTRACT

A storage assembly for storing one or more paint application devices includes a lid having a central axis and that is configured to couple with an open end of a bucket, wherein the lid includes an interior side defined by an interior surface of the lid and an exterior side that is opposite the interior side and is defined by an exterior surface of the lid, and a cylindrical first device holder extending axially from the interior side of the lid, wherein the first device holder is configured to couple with a central tube of a paint roller.

### CROSS-REFERENCE TO RELATED APPLICATIONS

This application claims benefit of both U.S. provisional patent application Ser. No. 63/403,414 filed Sep. 2, 2022 and entitled “Paint Application Device Storage Assembly,” and U.S. provisional patent application Ser. No. 63/422,497 filed Nov. 4, 2022 and entitled “Paint Application Device Storage Assembly,” both of which is hereby incorporated herein by reference in its entirety for all purposes.

### STATEMENT REGARDING FEDERALLY SPONSORED RESEARCH OR DEVELOPMENT

Not applicable.

### BACKGROUND

Paint is typically applied to walls or other surfaces to increase visual appeal as well as to protect the underlying surface (e.g., from moisture). Paint may be applied to a surface via one or more suitable paint application devices (e.g., hand-held paint application devices) including, for example, brushes, rollers, etc. Following a painting operation in which one or more surfaces are painted by one or more paint application devices, at least some of the paint application devices may be cleaned with water or other solvents to allow the cleaned paint application devices to be successfully reused in future painting operations.

### BRIEF SUMMARY OF THE DISCLOSURE

An embodiment of a storage assembly for storing one or more paint application devices comprises a lid having a central axis and that is configured to couple with an open end of a bucket, wherein the lid includes an interior side defined by an interior surface of the lid and an exterior side that is opposite the interior side and is defined by an exterior surface of the lid, and a cylindrical first device holder extending axially from the interior side of the lid, wherein the first device holder is configured to couple with a central tube of a paint roller. In some embodiments, the lid comprises a radially outer lip and wherein the interior surface of the lid is axially recessed from the outer lip. In some embodiments, an inner diameter of the outer lip is equal to or greater than an outer diameter of the interior surface of the lid. In certain embodiments, the storage assembly comprises a paint application device hanger extending axially form the interior side of the lid, wherein the device hanger comprises an elongate rod extending from the outer lip of the lid, and a hanger post extending radially outwards from the rod. In certain embodiments, the storage assembly comprises a paint application device hanger extending axially form the interior side of the lid, wherein the device hanger comprises an elongate rod extending from the interior surface of the lid, and a hanger post extending radially outwards from the rod. In some embodiments, the hanger post extends from the elongate rod at a non-zero angle that is equal to or less than ninety degrees. In some embodiments, the hanger post extends from the elongate rod at a non-zero angle that is less than ninety degrees. In certain embodiments, the lid is configured to releasably snap onto the open end of the bucket. In certain embodiments, the storage assembly comprises a cylindrical second device holder extending axially from the exterior surface of the lid. In some embodiments, the storage assembly comprises a cylindrical second device holder extending axially from the exterior side of the lid, wherein the second device holder comprises an outer cylindrical wall extending from the exterior surface of the lid, and a cavity formed within the cylindrical wall. In some embodiments, the second device holder comprises a paint brush holder.

An embodiment of a storage assembly for storing one or more paint application devices comprises a lid having a central axis and that is configured to couple with an open end of a bucket, wherein the lid includes an interior side defined by an interior surface of the lid and an exterior side that is opposite the interior side and is defined by an exterior surface of the lid, and a paint application device hanger extending axially form the interior side of the lid, wherein the device hanger comprises an elongate rod extending from the interior side of the lid, and a hanger post extending radially outwards from the rod. In certain embodiments, the device hanger comprises a paint brush hanger. In certain embodiments, the hanger post extends from the elongate rod at a non-zero angle that is equal to or less than ninety degrees. In some embodiments, the hanger post extends from the elongate rod at a non-zero angle that is less than ninety degrees. In some embodiments, the device hanger comprises a plurality of the hanger posts circumferentially spaced from each other and extending radially outwards from the rod. In certain embodiments, the storage assembly comprises a plurality of the device hangers extending from the interior side of the lid. In certain embodiments, the rod of the device hanger extends from the interior surface of the lid. In some embodiments, the lid comprises a radially outer lip and wherein the interior surface of the lid is axially recessed from the outer lip, and wherein the rod of the device hanger extends from the outer lip of the lid. In some embodiments, the storage assembly comprises a cylindrical first device holder extending axially from the exterior side of the lid, wherein the first device holder is configured to couple with a central tube of a paint roller.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a side cross-sectional view of a paint application device storage assembly according to some embodiments;

FIG. 2 is a side exploded view of a paint application device storage assembly according to some embodiments;

FIG. 3 is a side exploded view of a paint application device storage assembly according to some embodiments;

FIG. 4 is a side exploded view of a paint application device storage assembly according to some embodiments;

FIG. 5 is a side exploded view of a paint application device storage assembly according to some embodiments;

FIG. 6 is a side exploded view of a paint application device storage assembly according to some embodiments; and

FIG. 7 is a side exploded view of a paint application device storage assembly according to some embodiments.

### DETAILED DESCRIPTION

A previously described, paint may be applied to walls or other surfaces using suitable paint application devices (e.g., brushes, rollers, etc.). Following a painting job, the paint application devices may be washed (e.g., in water or other solvents) to remove excess paint therefrom. The washed paint application devices are then dried in order to allow them to be reused in a subsequent painting operation. However, it is often difficult to position the paint application devices such that all surfaces and portions of the paint application device fully dries. For instance, if a paint application device is laid on its side, the portion of the paint application device that is in contact with the other surface (e.g., table, floor, etc.) may not fully dry. In addition, whether the paint application device is washed or not following a painting operation, the paint application device may drip excess paint, water, and/or other liquids onto other surfaces, which may be undesirable.

Accordingly, embodiments disclosed herein include storage assemblies for paint application devices including brushes and/or rollers. In some embodiments, the storage assemblies may be configured as a lid of a bucket (e.g., a standard five-gallon bucket). In some embodiments, the storage assemblies described herein may allow paint application devices to be suspended from the lid so that the external surfaces of the paint applicant device may be free from contact with other surfaces or objects and so that paint, water, and/or other solvents may freely drip off of the paint application device and into the bucket.

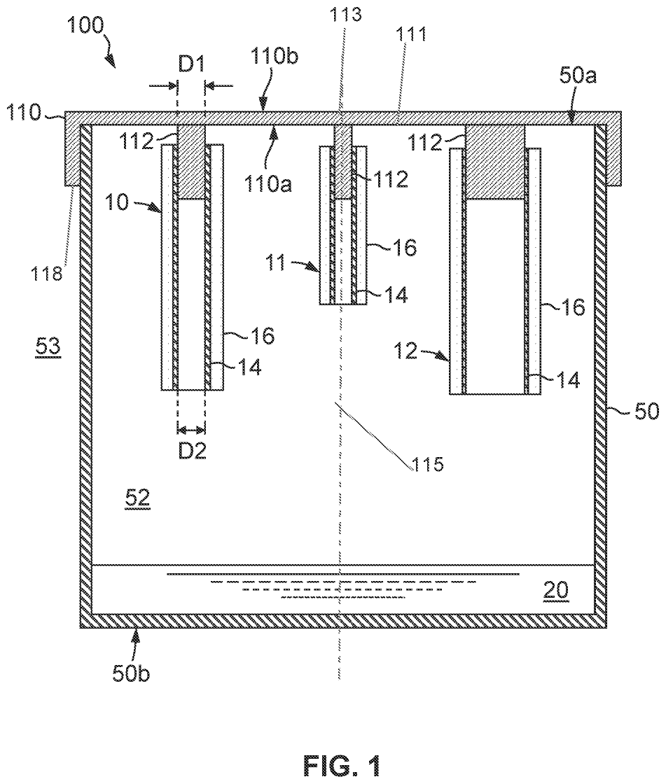

Referring now to FIG. 1, a storage assembly 100 for storing a plurality of separate paint application devices 10, 11, 12 is shown. In this exemplary embodiment, the storage assembly 100 comprises a lid 110 that is configured to fit onto a bucket 50 (e.g., a paint bucket). Particularly, in some embodiments, lid 110 comprises a radially outer lip 118 which is secured or positioned over an outer cylindrical surface of the bucket 50 when the lid 110 is coupled to the bucket 50.

The bucket 50 may comprise any suitable receptacle, such as a cylindrical bucket (e.g. a five-gallon bucket). In this exemplary embodiment, bucket 50 includes a first or open end 50a and a second or closed end 50b opposite open end 50a. A cavity or receptacle 52 is formed within bucket 50 that extends longitudinally from open end 50a to closed end 50b. Generally speaking, the bucket 50 may be oriented such that the closed end 50b is supported on the ground or other support surface and the open end 50a is located opposite closed end 50b. Thus, the closed end 50b may be referred to herein as the “lower end” of bucket 50, and the open end 50a may be referred to herein as the “upper end” of bucket 50.

The lid 110 of storage assembly 100 may be releasably secured to the upper end 50a of bucket 50 to thereby enclose the cavity 52 off from the external environment 53 surrounding bucket 50. In some embodiments, the lid 110 may seal the cavity 52 from external environment 53 so as to prevent (or at least greatly restrict) airflow between cavity 52 and environment 53 during operation. For instance, in some embodiments, an annular seal (e.g., an O-ring or other suitable seal) may be positioned or formed along an interior surface of the lid 110. In other embodiments, the lid 110 may not seal off cavity 52 from external environment 53 when secured to open end 50a. In addition, lid 110 may be secured to upper end 50a of bucket 50 via a friction fit, a threaded connection (e.g., via internal threads formed on an interior surface of lid 110 cooperating with external threads formed on the bucket 50), or any other suitable mechanism.

In this exemplary embodiment, lid 110 of storage assembly 100 is disc or hub-shaped having a central or longitudinal axis 115 and includes a first side 110a and a second side 110b opposite the first side 110a. The first side 110a may face inwardly towards cavity 52 while the opposing second side 110b may face away or outwardly from cavity 52 when lid 110 is secured to the upper end 50a of bucket 50. Thus, the first side 110a may be referred to herein as the “inner” or “interior” side and the second side 110b may be referred to herein as the “outer” or “exterior” side.

Interior side 110a of lid 110 includes one or more (e.g., a plurality of) connectors or device holders 112 distributed thereacross and project axially (e.g., parallel with central axis 115) or extend from an interior surface 111 of lid 110 that is opposite an exterior surface of the exterior side 110b. In some embodiments, interior surface 111 of lid 110 is axially recessed from the outer lip 118 of lid 110. Device holders 112 that are configured to engage and releasably couple with paint application devices 10, 11, 12. In some embodiments, device holders 112 may be circumferentially spaced about the interior surface 111. In other embodiments, device holders 112 may be spaced along a common linear axis extending along interior surface 111. In addition, it may be understood that the arrangement of device holders 112 along interior surface 111 may vary from the exampled provided herein.

For instance, in some embodiments, the paint application devices 10, 11, 12 may comprise paint rollers (or paint roller covers) that include a central tube 14 surrounded by a fibrous outer layer 16. Thus, the paint application devices 10, 11, 12, may be referred to herein as “rollers.” In some embodiments, the device holders 112 comprise cylindrical projections (e.g., having a constant or varying circular outer diameter) that extend from the interior surface 111 interior side 110a and that are configured to engage or couple with the central tubes 14 of rollers 10, 11, 12. Specifically, each device holder 112 may have an outer diameter D1 that is sized relative to an inner diameter D2 of the central tube 14 of the corresponding roller so that there is sufficient friction or interference between the central tube 14 and the device holder 112 to allow the roller 10, 11, 12 to be suspended from the interior side 110a of lid 110 as shown in FIG. 1. In this manner, the rollers 10, 11, and 12 may hang suspended within the cavity 52 of bucket 50 when lid 110 is coupled to the bucket 50.

For instance, in some embodiments, the outer diameter D1 of each device holder 112 may be sized such that they are approximately equal to or slightly larger than the inner diameter D2 of the central tube 14 of the corresponding roller 10, 11, 12. In addition, in some embodiments, the device holders 112 may have different outer diameters D1 so as to allow connection and engagement with differently sized rollers 10, 11, 12. For instance, in some embodiments, the device holders 112 may be configured into a plurality of different outer diameters D1 that correspond to the inner diameters D2 of a plurality of standard roller sizes. However, in some embodiments, the device holders 112 may all have the same sized outer diameter D1.

During operations, the rollers 11, 12, 13 may be suspended from the device holders 112 as shown, and lid 110 may be secured to upper end 50a of bucket 50. As a result, excess paint, water, etc. that is carried within the fibrous material 16 of rollers 10, 11, 12 may freely drip under the force of gravity from rollers 10, 11, 12 and subsequently fall into a collection 20 within cavity 52 at (or proximate to) lower end 50b of bucket 50. Thus, undesirable dripping of these excess liquids (e.g., paint) on other surfaces exterior of the bucket 50 (e.g., flooring, countertops, foundation) may be avoided.

In addition, assuming that sufficient airflow is allowed to access the rollers 10, 11, 12 while suspended from device holders 112, the lack of contact between the fibrous material 16 of rollers 10, 11, 12 and other objects/surfaces may allow for a more complete drying of the rollers 10, 11, 12 (e.g., such as after washing the rollers following a painting operation). For example, in some embodiments, a user of lid 110 may only partially secure or loosely position lid 110 on the upper end 50a of bucket 50 whereby sufficient airflow is permitted between the external environment and the cavity 52 of bucket 50 to permit drying of the rollers 10, 11, and 12.

Further, in some embodiments, when lid 110 is fully secured to upper end 50a of bucket 50 cavity 52 may be sealed from external environment 53 such that the fibrous material 16 of rollers 10, 11, 12 may be prevented from drying out. As a result, one may place used rollers 10, 11, 12 onto device holders 112 in the manner shown in FIG. 1 and store them for a period (e.g., overnight) without risk of paint drying on the fibrous material 16 of used rollers 10, 11, and 12. As a result, by storing rollers 10, 11, 12 on device holders 112 of lid 110 and sealing the cavity 52 via sealing engagement between lid 110 and upper end 50a as described herein, rollers 10, 11, 12 may be used a plurality of times (over multiple days) without needing to wash the rollers between uses. The ability to reuse (without rushing) rollers 10, 11, and 12 in multiple painting operations may save the user valuable time and expense when performing the painting operations.

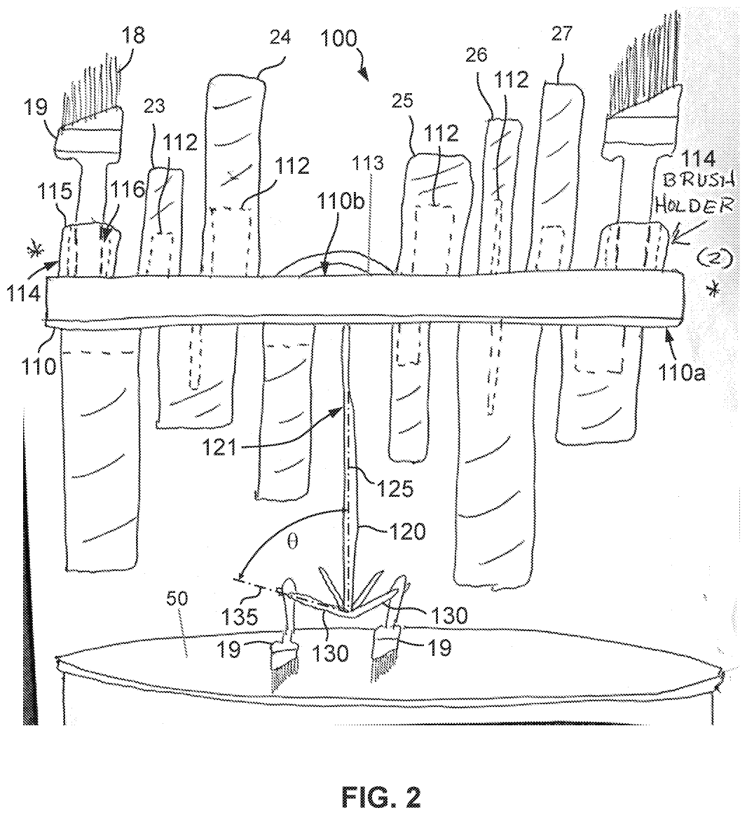

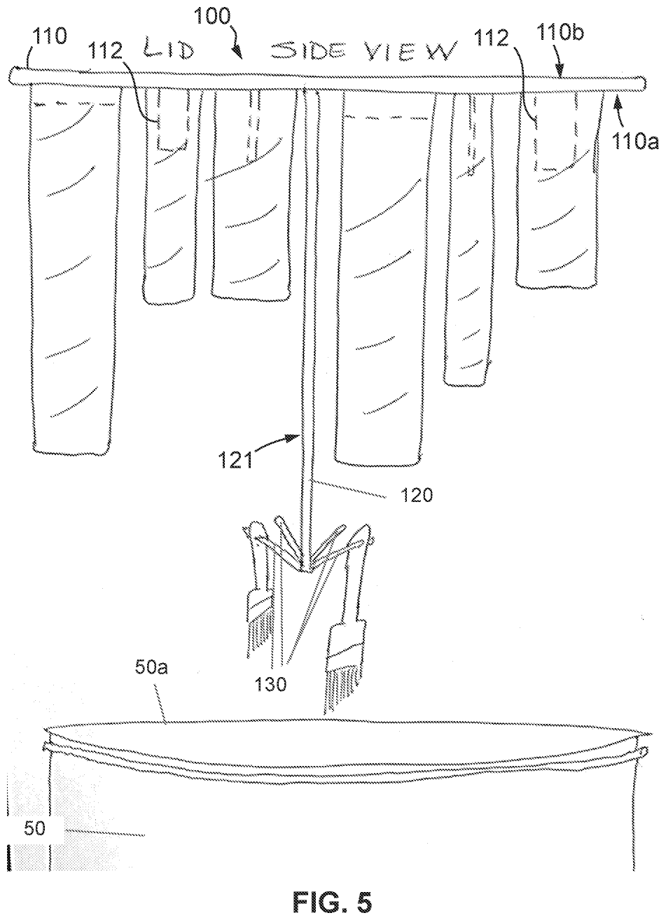

Further features of embodiments of paint application device storage assemblies (e.g., assembly 100) are described herein with reference to additional FIGS. 2-6. It should be understood that various embodiments are contemplated in which various combinations of features described herein are utilized within a paint application storage assembly. Thus, while particular embodiments are shown and described, additional embodiments and combinations thereof are further contemplated.

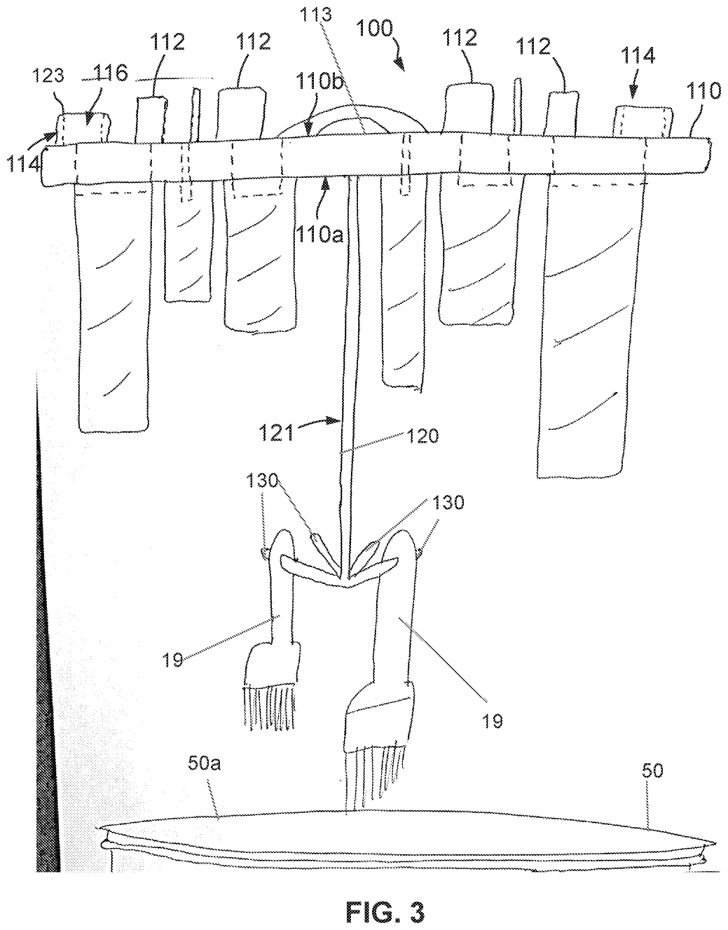

Referring now to FIGS. 2 and 3, in some embodiments a plurality of device holders 112 are positioned along an exterior surface 113 of exterior side 110b of lid 110 either in lieu of or in addition to interior side 110a. The device holders 112 positioned along exterior surface 113 may be referred to herein as external device holders 112 while the device holders 112 positioned on interior surface 111 may be referred to herein as internal device holders 112. Similar to internal device holders 112, in some embodiments, external device holders 112 may comprise cylindrical projections which extend axially (e.g., parallel with central axis 115) from exterior surface 113.

The device holders 112 on exterior side 110b of lid 110 may be similarly configured to the device holders 112 positioned along the interior side 110a. In some embodiments, the device holders 112 on exterior side 110b may have outer diameters (e.g., D1 shown in FIG. 1) that are substantially smaller than the inner diameters of external rollers 23, 24, 25, 26, 27 that are engaged therewith because the exterior side 110b of lid 110 may provide direct support to these rollers 23, 24, 25, 26, 27 during operations. The provisioning of lid 110 with external device holders 112 may thus maximize the number of paint application devices which lid 110 may hold or carry at a given time.

In addition, in some embodiments, one or more external connectors or device holders 114 may also extend or project from the exterior surface 113 of exterior side 110b. In some embodiments, external device holders 114 are configured to hold (e.g., hold in a generally upright or vertical orientation) a paint application device such as, for example, a paint brush. For instance, the device holders 114 may comprise an outer cylindrical wall 123 which extends axially from exterior surface 113 and defines a cavity (e.g., a central cavity 116 therein. A paint brush 19 may inserted, handle-down into the cavity 116 and leaned against the cylindrical wall 115 to prevent the bristles 18 from contacting other surfaces or objects. Several such paint application devices may each be partially received in the cavity 116 of a given device holder 114 as needed.

Referring still to FIGS. 2 and 3, in some embodiments, lid 110 includes a paint application device hanger 121 (e.g., a paint brush hanger 121) which projects or extends axially from the interior surface 111 of lid 110 such that device hanger 121 is suspended from the interior surface 111. The device hanger 121 may include a central, elongate rod 120 that extends axially from interior surface 111 along a central axis 125. In some embodiments, central axis 125 of device hanger 121 is coincident with central axis 115 of lid 110 while in other embodiments, central axis 125 is laterally spaced from central axis 115.

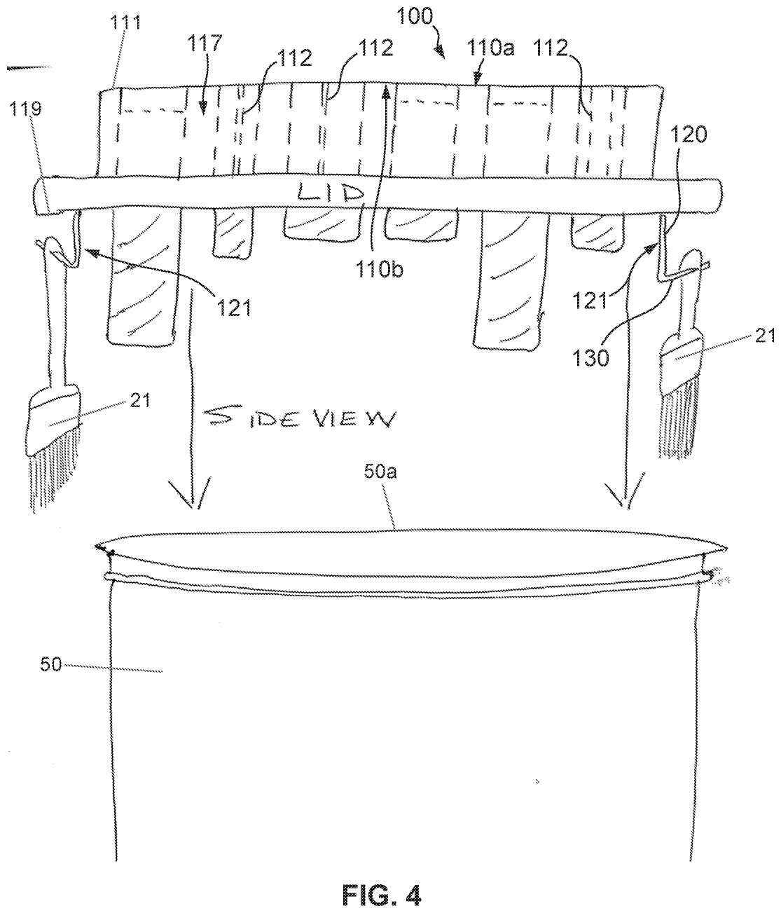

In addition, device hanger 121 may include a plurality of hanger posts 130 extending radially outwards (with respect to axis 125) from rod 120 (e.g., from a terminal end of rod 120). Each hanger post 130 may have its own central axis 135 (one of which is shown in FIG. 2). In some embodiments, the hanger posts 130 may each extend at angles relative to central rod 120 so that, for example, axes 135 are positioned at an angle θ to axis 125 of rod 120. In some embodiments, the angle θ may be greater than 0° and less than or equal to 90°. In certain embodiments, the angle θ may be greater than 0° and less than or equal to 120°. In some embodiments, the paint brush hanger 121 may include a single hanger post 130 (e.g., such as shown in FIG. 4).

Typically, handles of paint brushes 19 may have an aperture formed therein proximal a terminal end of the handle. Thus, the hanger posts 130 may be extended through the apertures in the handles of paint brushes 19 so that paint brushes 19 may be suspended from paint brush hanger 121 during operations.

Referring now to FIG. 4, in some embodiments, the interior side 110a of lid 110 may be recessed upward (e.g., when lid 110 is secured to upper side 50a of bucket 50) to form or expand an internal cavity 117 defined by the interior surface 111 of lid 110. In this configuration, an annular hub surface 119 is formed having an inner diameter that is equal to or greater than the outer diameter of interior surface 111. Additionally, hub surface 119 is spaced along central axis 115 from the interior surface 111. Further, in some embodiments, the inner diameter of hub surface 119 may be equal to or greater than an outer diameter of the bucket 50 such that hub surface 119 remains external the cavity 52 of bucket 50 when lid 110 is secured to the upper end 50a of bucket 50.

The device holders 112 may be entirely or partially positioned within the cavity 117. Without being limited to this or any other theory, the cavity 117 may increase a vertical clearance between the device holders 112 and the lower end 50b of bucket 50 (FIG. 1) so that longer brushes 19 and rollers (rollers 10-17) may be suspended therefrom without contacting the closed end 50b of bucket 50. In some embodiments, one or more device hangers 121 may project or extend from hub surface 119 whereby paint application devices (e.g., paint brushes 21 shown in FIG. 4) may be suspended from lid 110 external the cavity 52 of bucket 50 when the lid 110 is secured to the upper end 50a of bucket 50.

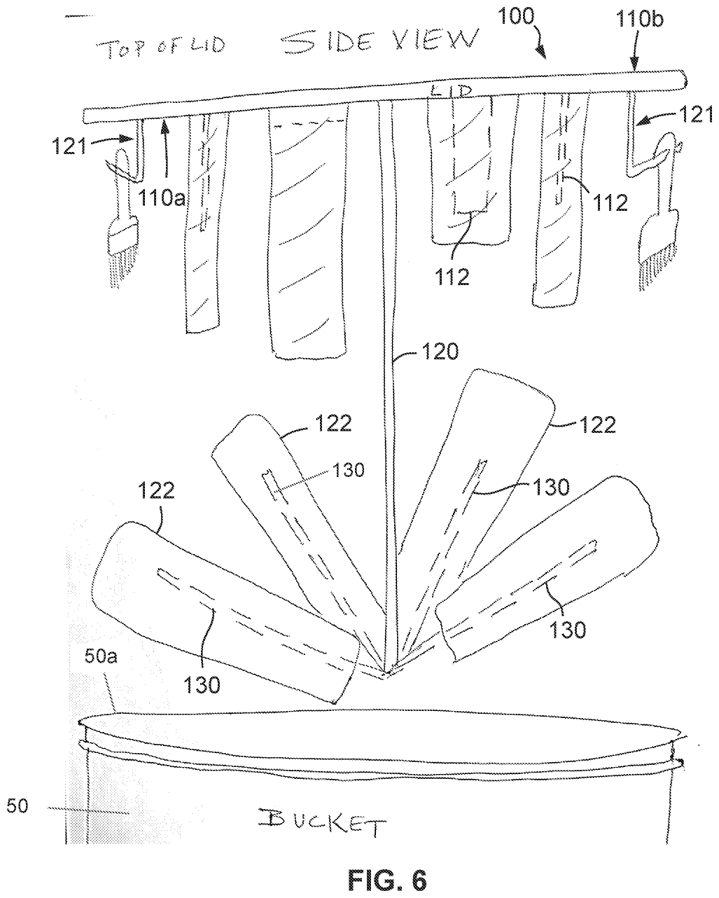

Referring now to FIG. 6, in some embodiments, the hanger posts 130 of a paint brush hanger 121 suspended from interior side 110a of lid 110 may be sized and spaced so that additional rollers 122 can be coupled to hanger posts 130 and suspended from the interior side 110a of lid 110. In some embodiments, hanger posts 130 may be inclined relative to the horizontal (e.g., when lid 110 is level to the horizontal) to prevent the additional rollers 122 from slipping off of hanger posts 130.

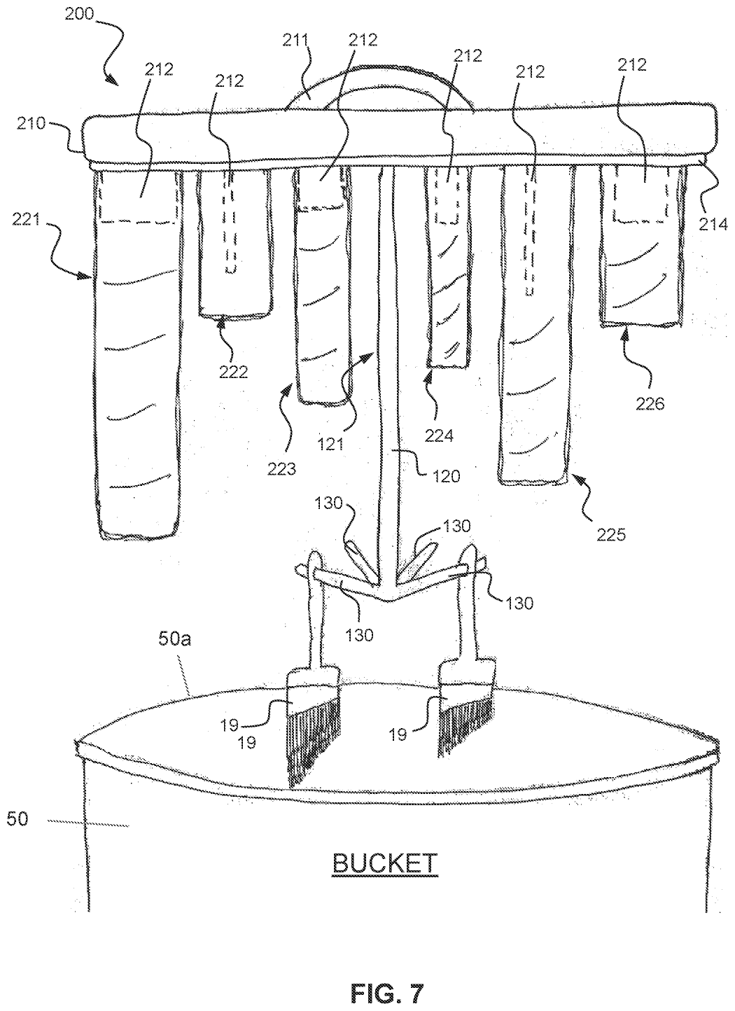

Referring now to FIG. 7, another embodiment of a storage assembly 200 for a plurality of paint application devices 10, 11, 12 is shown. Storage assembly 200 includes features in common with the storage assembly 100 shown in FIGS. 1-6, and shared features are labeled similarly. Particularly, storage assembly 200 includes a lid 210 securable to a bucket which may be similar in configuration to the bucket 50 shown in FIG. 1. In some embodiments, the lid 210 may seal an internal cavity of the bucket from the outside, external environment so as to prevent (or at least restrict) airflow between the internal cavity and the external environment when the lid 210 is secured to the bucket. In some embodiments, the lid 210 may not seal off the internal cavity from the external environment when secured to the bucket. Additionally, in this exemplary embodiment, lid 210 comprises external threads 214 for threadably coupling to corresponding threads of the bucket whereby the lid 210 comprises a screw lid or top. However, it may be understood that in other embodiments the lid 210 of storage assembly 200 may be secured to an upper end of the bucket via a friction fit, or any other suitable mechanism. For example, in some embodiments, lid 210 comprises one or more snap connectors located along a periphery thereof and which snap into corresponding grooves formed on the bucket.

In this exemplary embodiment, lid 210 of storage assembly 200 generally includes a handle 211 extending from an exterior side of the lid 210, one or more connectors or device holders 212 extending from an interior side of the lid 210, threads 214, and paint brush hanger 121 also extending from the interior side of lid 210. Device holders 212 are distributed across the interior side of lid 210 and are configured to engage with one or more corresponding paint application devices 221-226 in this exemplary embodiment. Paint application devices 221-226 may be similar in configuration to the paint application devices 10-12 described above. Thus, paint application devices 221-226 may comprise rollers each having a central tube surrounded by a fibrous outer layer, and paint application devices 221-226 may also be referred to herein as rollers 221-226.

The device holders 212 of lid 210 may be configured similarly in some embodiments as the device holders 112 of the lid 110 described above. Thus, in some embodiments, device holders 212 may comprise cylindrical projections that extend outward (e.g., normally outward) from the interior side that are configured to engage with the central tubes of rollers 221-226. Specifically, each device holder 212 may have an outer diameter that is sized relative to an inner diameter of the central tube of a corresponding roller 221-226 so that there is sufficient friction or interference between the central tube of the roller 221-226 and the device holder 212 to allow the given roller 221-226 to be suspended downward from the interior side of lid 210. For instance, in some embodiments, the outer diameter of each device holder 212 may be sized such that they are approximately equal to or slightly larger than the inner diameter of the central tube of the corresponding roller 221-226. In addition, in some embodiments, the device holders 212 may have different outer diameters so as to allow connection and engagement with differently sized rollers 221-226. Further, in addition to the device holders 212, in this exemplary embodiment, the interior side of lid 210 includes the paint brush hanger 121 from which one or more paint brushes 19 may be suspended.

The discussion herein is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the discussion herein and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used herein (including in the claims), the words “about,” “generally,” “substantially,” “approximately,” and the like mean within a range of plus or minus 10%.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A storage assembly for storing one or more paint application devices, the storage assembly comprising:
a lid having a central axis and that is configured to couple with an open end of a bucket, wherein the lid includes an interior side defined by an interior surface of the lid and an exterior side that is opposite the interior side and is defined by an exterior surface of the lid; and
a cylindrical first device holder extending axially from the interior side of the lid, wherein the first device holder is configured to couple with a central tube of a paint roller.

2. The storage assembly of claim 1, wherein the lid comprises a radially outer lip and wherein the interior surface of the lid is axially recessed from the outer lip.

3. The storage assembly of claim 2, wherein an inner diameter of the outer lip is equal to or greater than an outer diameter of the interior surface of the lid.

4. The storage assembly of claim 2, further comprising a paint application device hanger extending axially form the interior side of the lid, wherein the device hanger comprises:
an elongate rod extending from the outer lip of the lid; and
a hanger post extending radially outwards from the rod.

5. The storage assembly of claim 1, further comprising a paint application device hanger extending axially form the interior side of the lid, wherein the device hanger comprises:
an elongate rod extending from the interior surface of the lid; and
a hanger post extending radially outwards from the rod.

6. The storage assembly of claim 5, wherein the hanger post extends from the elongate rod at a non-zero angle that is equal to or less than ninety degrees.

7. The storage assembly of claim 5, wherein the hanger post extends from the elongate rod at a non-zero angle that is less than ninety degrees.

8. The storage assembly of claim 1, wherein the lid is configured to releasably snap onto the open end of the bucket.

9. The storage assembly of claim 1, further comprising a cylindrical second device holder extending axially from the exterior surface of the lid.

10. The storage assembly of claim 3, further comprising a cylindrical second device holder extending axially from the exterior side of the lid, wherein the second device holder comprises:
an outer cylindrical wall extending from the exterior surface of the lid; and
a cavity formed within the cylindrical wall.

11. The storage assembly of claim 10, wherein the second device holder comprises a paint brush holder.

12. A storage assembly for storing one or more paint application devices, the storage assembly comprising:
a lid having a central axis and that is configured to couple with an open end of a bucket, wherein the lid includes an interior side defined by an interior surface of the lid and an exterior side that is opposite the interior side and is defined by an exterior surface of the lid; and
a paint application device hanger extending axially form the interior side of the lid, wherein the device hanger comprises an elongate rod extending from the interior side of the lid, and a hanger post extending radially outwards from the rod.

13. The storage assembly of claim 12, wherein the device hanger comprises a paint brush hanger.

14. The storage assembly of claim 12, wherein the hanger post extends from the elongate rod at a non-zero angle that is equal to or less than ninety degrees.

15. The storage assembly of claim 12, wherein the hanger post extends from the elongate rod at a non-zero angle that is less than ninety degrees.

16. The storage assembly of claim 12, wherein the device hanger comprises a plurality of the hanger posts circumferentially spaced from each other and extending radially outwards from the rod.

17. The storage assembly of claim 12, further comprising a plurality of the device hangers extending from the interior side of the lid.

18. The storage assembly of claim 12, wherein the rod of the device hanger extends from the interior surface of the lid.

19. The storage assembly of claim 12, wherein the lid comprises a radially outer lip and wherein the interior surface of the lid is axially recessed from the outer lip, and wherein the rod of the device hanger extends from the outer lip of the lid.

20. The storage assembly of claim 12, further comprising a cylindrical first device holder extending axially from the exterior side of the lid, wherein the first device holder is configured to couple with a central tube of a paint roller.
